(19) United States
(12) Patent Application Publication
(10) Pub. No.: US 2025/0371261 A1
(43) Pub. Date: Dec. 4, 2025

(54) SYSTEMS AND METHODS FOR MANAGING SENSITIVE DATA

(71) Applicant: Comcast Cable Communications, LLC, Philadelphia, PA (US)

(72) Inventors: Brad CZERKIES, Madras, OR (US); Rima SHAH, Erie, CO (US); Syed Arshad Ali RAZVI, Highlands Ranch, CO (US); Maria BATTLE-MILLER, Centennial, CO (US)

(21) Appl. No.: 18/676,805

(22) Filed: May 29, 2024

(51) Int. Cl. G06F 40/20

(52) U.S. Cl. CPC G06F 40/20

(57) ABSTRACT

Methods and systems for managing sensitive data are disclosed. Data indicative of a request may be received. The data may comprise sensitive information, such as information that a user does not want a machine learning model to access. The data may be transformed into a modified request based on replacing at least one portion of the sensitive information with generic information. A response to the request may be generated based on sending the modified request to the machine learning model. The machine learning model may be configured to generate data indicative of the response to the request without accessing the sensitive information.

### BACKGROUND

Machine learning models, such as large language models, are increasingly being used to perform various tasks, including decision-making tasks, natural language processing tasks, classification tasks, content generation, and/or the like. Machine learning models may be able to perform such tasks more efficiently and/or more accurately than human users. However, it may be undesirable to provide machine learning models with access to sensitive data. As such, users may avoid using machine learning models to perform tasks that involve sensitive data. These and other shortcomings are addressed by the present disclosure.

### SUMMARY

Methods, systems, and devices for managing sensitive (e.g., proprietary, confidential, secret) data are disclosed. A user may request that a machine learning model perform a task involving sensitive data. However, the user may not want to provide the machine learning model with access to the sensitive data. To prevent the machine learning model from accessing the sensitive data, the request may be transformed into a generic (e.g., general, non-proprietary, not sensitive) request, such as by removing at least a portion of the sensitive data. The machine learning model may receive the modified request and generate a response to the modified request without accessing the sensitive data. The response to the modified request may be transformed into an actual response to the initial request, such as by replacing generic data in the generic response with the sensitive data that was previously removed. In this manner, the user may be able to utilize the machine learning model to perform tasks involving sensitive data while preventing the machine learning model from collecting and/or storing the sensitive data.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 is an example system.

FIG. 2 is an example system.

FIG. 3 is an example system.

FIG. 4 is an example method.

FIG. 5 is an example method.

FIG. 6 is an example method.

FIG. 7 is an example computing device.

### DETAILED DESCRIPTION OF ILLUSTRATIVE EMBODIMENTS

Methods and systems for managing sensitive (e.g., proprietary, confidential, secret) data are disclosed. An entity (e.g., an individual user, a company, an employee of a company, etc.) may need to perform a task that involves sensitive data. The sensitive data may include personal information, customer data, trade secrets, variable names, proprietary code, and/or the like. The task may include a decision-making task, a natural language processing task, a classification task, a content generation task, and/or any other type of task. The user may want to use a machine learning model to perform the task, as the machine learning model is likely able to perform the task faster and/or more accurately than the user would otherwise be able to. However, machine learning models may collect and/or store all data that they receive. The user may not want the machine learning model to collect and/or store the sensitive data. For example, providing the machine learning model with access to the sensitive data can violate confidentiality agreements, data privacy laws, and/or can cause the machine learning model to expose sensitive data to other users.

Described herein are techniques that enable users to take advantage of the benefits provided by machine learning models while also preventing the machine learning models from accessing sensitive data. A sensitive data protection service may enable users to interact in a secure way with machine learning models. A user may submit a request for a machine learning model to perform a task. If the request comprises sensitive data, the sensitive data protection service may transform the request into a generic (e.g., general, non-proprietary, not sensitive) request by removing at least a portion of the sensitive data from the request and/or by replacing the at least a portion of the sensitive data with generic data. The sensitive data protection service may add garbage (e.g., dummy, obfuscation) information to the modified request to further obfuscate the sensitive data.

The sensitive data protection service may send the modified request to the machine learning model. The machine learning model may receive the modified request and generate a generic response to the modified request without accessing the sensitive data. The machine learning model may send the generic response back to the sensitive data protection service. The sensitive data protection service may transform the generic response into an actual response to the user's initial request by removing at least a portion of the generic data from the modified request and/or by replacing at least a portion of the generic data with the sensitive data that was previously removed. In this manner, the user may be able to utilize the machine learning model to perform the task involving sensitive data while preventing the machine learning model from collecting and/or storing the sensitive data.

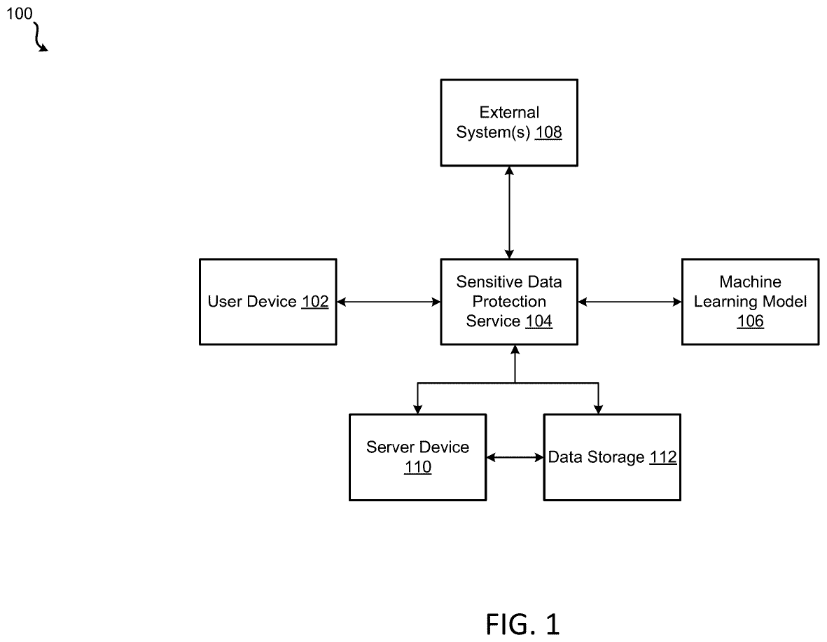

FIG. 1 shows an example system 100. The system 100 may comprise a user device 102, a sensitive data protection service 104, a machine learning model 106, one or more external systems 108, a server device 110, and a data storage 112. It should be noted that while the singular term device is used herein, it is contemplated that some devices may be implemented as a single device or a plurality of devices (e.g., via load balancing). The user device 102, the sensitive data protection service 104, the machine learning model 106, the external system(s) 108, the server device 110, and the data storage 112 may each be implemented as one or more computing devices. The sensitive data protection service 104 may comprise middleware that is implemented using one or more computing nodes, such as virtual machines, executed on a single device and/or distributed across multiple devices.

A user associated with the user device 102 may use the user device 102 to send (e.g., submit) a request. The request may comprise sensitive data, such as personal information, customer data, trade secrets, variable names, proprietary code, and/or the like. The request may comprise a request for a task to be performed by the machine learning model 106 using the sensitive data. The user device 102 may comprise a computing device, a smart device (e.g., smart glasses, smart watch, smart phone), a mobile device, a tablet, a computing station, a laptop, a digital streaming device, a streaming stick, a television, and/or the like. The machine learning model 106 may be configured to perform natural language processing. For example, the machine learning model 106 may comprise a large language model (LLM). The machine learning model 106 may be configured to perform any other type of task, such as decision-making tasks, classification tasks, content generation, and/or the like.

The request may comprise audio (e.g., speech), such as audio that the user captured using a microphone of the user device 102. Alternatively, the request may comprise text (e.g., natural language). The request may comprise code written in a programming language. For example, the request may comprise a request for the machine learning model 106 to modify or optimize the code. The request may comprise a request for the machine learning model 106 to perform some task related to the external system(s) 108. For example, the request may comprise a request for the machine learning model 106 to publish modified or optimized code to the external system(s) 108.

The sensitive data protection service 104 may receive the request. If the request comprises audio, the sensitive data protection service 104 may convert the audio into text. The sensitive data protection service 104 may convert the audio into text using any suitable speech-to-text conversion technique. The sensitive data protection service 104 may transform the request into a generic (e.g., general, non-proprietary, not sensitive) request. The sensitive data protection service 104 may transform the request into the modified request by removing at least a portion of the sensitive data from the request. The sensitive data protection service 104 may transform the request into the modified request by replacing the at least a portion of the sensitive data with generic data. The sensitive data protection service 104 may add garbage (e.g., dummy, obfuscation) information to the modified request to further obfuscate the sensitive data.

The sensitive data protection service 104 may send the modified request to the machine learning model 106. The machine learning model 106 may receive the modified request and generate a generic response to the modified request without accessing the sensitive data contained in the request. The machine learning model 106 may send the generic response back to the sensitive data protection service 104. The sensitive data protection service 104 may transform the generic response into an actual (e.g., non-generic) response to the user's initial request by removing at least a portion of the generic data from the generic response and/or by replacing at least a portion of the generic data in the generic response with the sensitive data that was previously removed.

In this manner, the user may be able to utilize the machine learning model 106 to perform tasks involving sensitive data (e.g., generating a response to a request comprising sensitive data) while preventing the machine learning model 106 from collecting and/or storing the sensitive data. This may be particularly advantageous given that the machine learning model 106 is likely able to perform the task faster and/or more accurately than the user would otherwise be able to. The user can take advantage of the speed and efficiency provided by the machine learning model 106 without having to worry that the machine learning model 106 is accessing sensitive data.

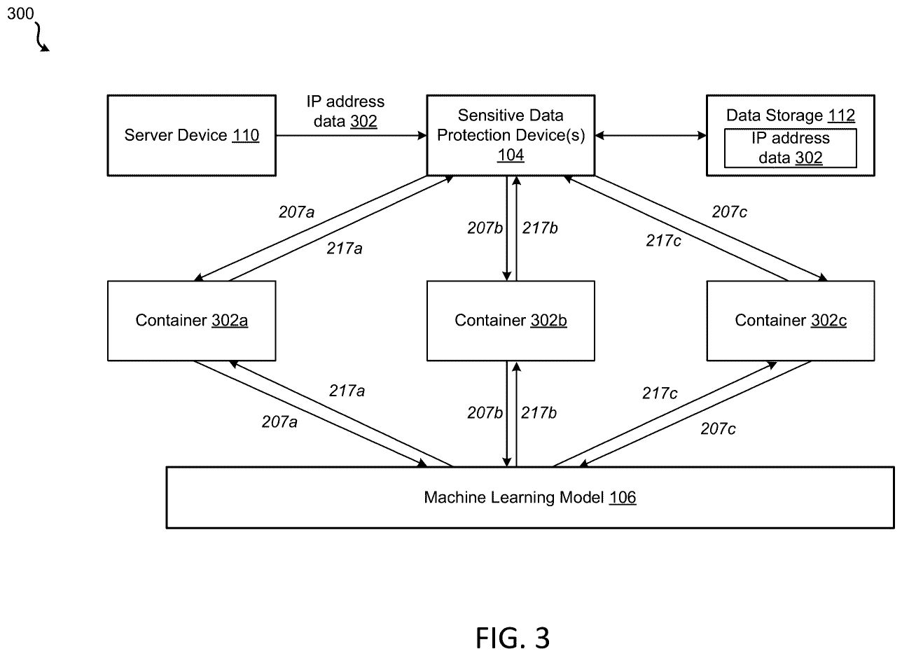

The sensitive data protection service 104 may send the modified request to the machine learning model 106 in chunks in order to further obfuscate the sensitive data. The sensitive data protection service 104 may divide the modified request into any number of chunks. The sensitive data protection service 104 may send the various chunks to the machine learning model 106 using different internet protocol (IP) addresses. For example, the sensitive data protection service 104 may send a first chunk to the machine learning model 106 using a first IP address, a second chunk to the machine learning model 106 using a second IP address, and so on. The server device 110 may comprise a dynamic host configuration protocol (DHCP) server. The server device 110 may determine IP addresses, such as IP addresses associated with cable modems and/or mobile devices. The IP addresses may be associated with shortened leases (e.g., DHCP leases that are minutes, hours, or days long). The server device 110 may cause temporary storage of the IP addresses in the data storage 112. The sensitive data protection service 104 may access the IP addresses stored in the data storage 112. The sensitive data protection service 104 may use the IP addresses stored in the data storage 112 to send the modified request chunks to the machine learning model 106. If the sensitive data protection service 104 sends the modified request to the machine learning model 106 in chunks, the sensitive data protection service 104 may receive the generic response from the machine learning model 106 in chunks. Such sending and receiving of data in chunks is discussed in more detail below with regard to FIG. 3.

The sensitive data protection service 104 may send the non-generic response to the user's initial request back to the user device 102. If the request comprises a request for the machine learning model 106 to perform some task related to the external system(s) 108, the sensitive data protection service 104 may additionally, or alternatively, send the non-generic response to the external system(s) 108.

The machine learning model 106 may be unable to interface with the external system(s) 108. The external system(s) 108 may comprise systems that are located in different data centers. The external system(s) 108 may comprise one or more software development systems and/or software production systems. For example, a user may request for the machine learning model 106 to optimize a piece of code and to publish the optimized code to his or her development system. The non-generic response to the request may comprise the optimized code. The sensitive data protection service 104 may send the optimized code to the user's development system. The sensitive data protection service 104 may send an acknowledgement to the user device 102. The acknowledgement may indicate that the optimized code has been deployed to the user's development system.

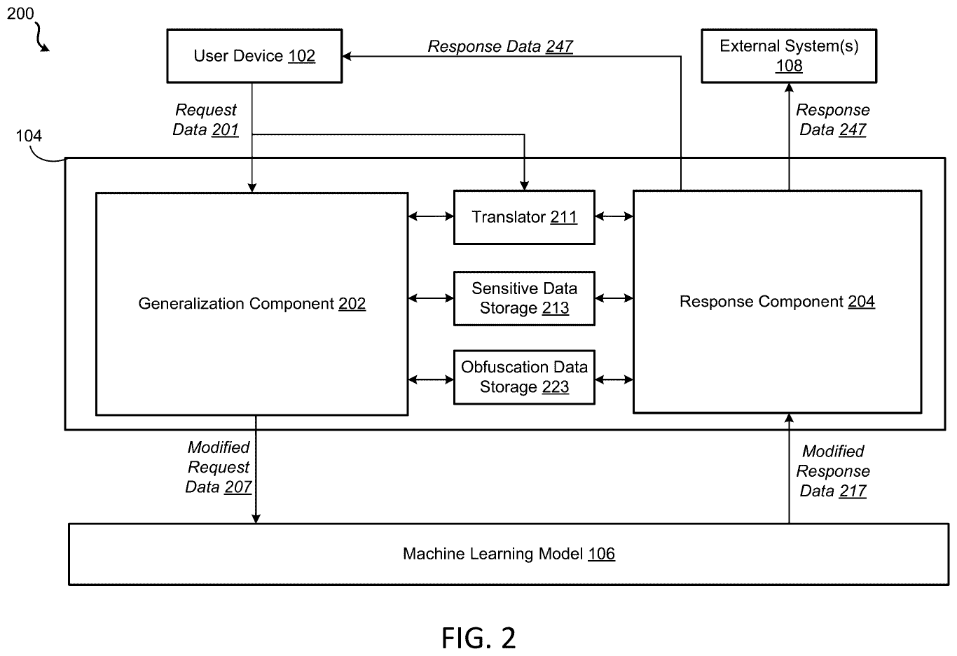

FIG. 2 shows an example system 200. The system 200 may comprise the user device 102, the sensitive data protection service 104, the machine learning model 106, and the external system(s) 108. The sensitive data protection service 104 may comprise a generalization component 202, a response component 204, a translator 211, a sensitive data storage 213, and an obfuscation data storage 233.

The system 200 may receive request data 201 from the user device 102. The request data 201 may comprise sensitive data, such as personal information, customer data, trade secrets, variable names, proprietary code, and/or the like. The request data 201 may be indicative of a request. The request may be a request that the machine learning model 106 perform a task, such as a task associated with the sensitive data. The request data 201 may comprise text (e.g., natural language). The request data 201 may comprise code written in a programming language. For example, the request data 201 may be indicative of a request for the machine learning model 106 to modify or optimize code. The request data 201 may be indicative of a request for the machine learning model 106 to perform some task related to the external system(s) 108. For example, the request may comprise a request for the machine learning model 106 to publish modified or optimized code to the external system(s) 108. If the request data 201 comprises text written in a language (e.g., programming language or spoken language) that is incompatible with (e.g., not understood or consumable by) the machine learning model 106, the translator 211 may translate the text into a different language that is compatible with (e.g., understood or consumable by) the machine learning model 106.

The generalization component 202 may be configured to transform the request data 201 into modified request data 207. If the text associated with the request data 201 has been translated into a different language, the generalization component 202 may be configured to transform the request data 201 comprising the translated text into the modified request data 207. The generalization component 202 may be configured to transform the request data 201 into the modified request data 207 based on removing (e.g., stripping) at least a portion of the sensitive data from the request data 201. For example, the generalization component 202 may transform the request data 201 into modified request data 207 by removing personal information, customer data, trade secrets, and/or variable names from the request data 201. The generalization component 202 may store the sensitive data that has been removed from the request data 201 in the sensitive data storage 213. The sensitive data storage 213 may comprise a secure database. The machine learning model 106 may be unable to access the sensitive data storage 213 and/or the sensitive data stored in the sensitive data storage 213.

The generalization component 202 may transform the request data 201 into modified request data 207 based on replacing at least one portion of the sensitive information with generic information. Replacing the at least one portion of the sensitive information with generic information may comprise replacing at least some of the sensitive information that is remaining after removing (e.g., stripping) the personal information, customer data, trade secrets, and/or variable names from the request data 201. The generalization component 202 may replace the at least one portion of the sensitive information with generic information using one or more generative artificial intelligence (AI) models. The generative AI models may be configured to translate (e.g., transform, replace) the request data 201 (or the portion of the request data 201 that is remaining after at least some of the sensitive information was removed) into the modified request data 207.

The generalization component 202 may determine if the modified request data 207 satisfies a threshold. The generalization component 202 may determine if the modified request data 207 satisfies a threshold based on one or more scores associated with the modified request data 207. The generalization component 202 may determine the score(s) associated with the modified request data 207. The score(s) may indicate how general (e.g., generic) the modified request data 207 is. If the score(s) satisfy (e.g., meets or exceeds) the threshold, this may indicate that the modified request data 207 is generic enough to be sent to the machine learning model 106. For example, if the score(s) satisfy (e.g., meets or exceeds) the threshold, this may indicate that an amount of the sensitive information associated with the modified request data 207 is less than or equal to a target level of sensitive information.

Alternatively, if the score(s) do not satisfy (e.g., does not meet or exceed) the threshold, this may indicate that the modified request data 207 still contains too much sensitive data (e.g., is not generic enough) to be sent to the machine learning model 106. For example, if the score(s) do not satisfy (e.g., meet or exceed) the threshold, this may indicate that an amount of the sensitive information associated with the modified request data 207 is greater than a target level of sensitive information.

If the modified request data 207 is not generic enough to be sent to the machine learning model 106, the generalization component 202 may add garbage (e.g., dummy, obfuscation) information to the modified request data 207 to further obfuscate the sensitive data. The generalization component 202 may retrieve the garbage information from the obfuscation data storage 223. The generalization component 202 may add the retrieved garbage information to the modified request data 207. Based on adding the garbage information to the modified request data 207, the generalization component 202 may determine one or more updated scores associated with the modified request data 207 (with the added garbage information). If the updated score(s) satisfy (e.g., meets or exceeds) the threshold, this may indicate that the modified request data 207 (with the added garbage information) is now generic enough to be sent to the machine learning model 106. Alternatively, if the updated score(s) do not satisfy (e.g., do not meet or exceed) the threshold, this may indicate that the modified request data 207 (with the added garbage information) still contains too much sensitive data to be sent to the machine learning model 106. The generalization component 202 may continue adding garbage (e.g., dummy, obfuscation) information to the modified request data 207 until the score satisfies the threshold.

Determining the one or more scores associated with the modified request data 207 may comprise determining a score for each statement (e.g., sentence) and/or word associated with the modified request data 207. The score may indicate how general (e.g., generic) that statement or word is. The generalization component 202 may assign the score to each statement and/or word associated with the modified request data 207 by comparing each statement and/or word to known statements and/or known words stored in a generalization dataset. The generalization dataset may indicate a score for each of the known statements and/or known words. If a statement and/or word associated with the modified request data 207 corresponds to (e.g., aligns with, is the same as, is similar to) a known statement and/or word stored in the generalization dataset, the generalization component 202 may assign the corresponding score to the statement and/or word. The generalization component 202 may compare each the scores for each statement and/or word to the threshold. Alternatively, the generalization component 202 may aggregate (e.g., combine) the scores for each statement and/or word and compare the aggregated score to the threshold.

The sensitive data protection service 104 may send the modified request data 207 to the machine learning model 106. The machine learning model 106 may receive the modified request data 207 and generate a generic response to the modified request data 207 without ever accessing the sensitive data contained in the request data 201. The machine learning model 106 may send generic response data 217 indicative of the generic response back to the sensitive data protection service 104 (e.g., to the response component 204 of the sensitive data protection service 104).

The response component 204 of the sensitive data protection service 104 may transform the generic response data 217 into actual (e.g., non-generic) response data 247. The actual response data 247 may be indicative of a response to the user's initial request. The sensitive data protection service 104 may transform the generic response data 217 into the actual response data 247 by removing at least a portion of the generic data from the modified request and/or by replacing at least a portion of the generic data with the sensitive data that was previously removed. Replacing the generic data with the sensitive data that was previously removed may comprise retrieving the sensitive data that was previously removed from the sensitive data storage 213.

The response component 204 of the sensitive data protection service 104 may transform the generic response data 217 into the actual response data 247 based on testing the generic response data 217. The response component 204 may test the generic response data 217 based on determining if the generic response data 217 provides an appropriate (e.g., suitable, helpful, sufficient) response to the user's initial request. If the response component 204 determines that the generic response data 217 provides an appropriate response to the user's initial request, the sensitive data protection service 104 (e.g., the response component 204) may transform the generic response data 217 into the actual response data 247.

If the response component 204 determines that the generic response data 217 does not provide an appropriate response to the user's initial request, the sensitive data protection service 104 (e.g., the response component 204) may generate an updated modified request to the to the machine learning model 106. The sensitive data protection service 104 (e.g., the response component 204) may send the updated modified request to the to the machine learning model 106. The machine learning model 106 may receive the updated modified request. The machine learning model 106 may generate an updated generic response based on the updated modified request. The machine learning model 106 may send updated generic response data indicative of the updated generic response back to the sensitive data protection service 104 (e.g., to the response component 204 of the sensitive data protection service 104). The sensitive data protection service 104 (e.g., the response component 204) may test the updated generic response data based on determining if the updated generic response data provides an appropriate (e.g., suitable, helpful, sufficient) response to the user's initial request. This process may repeat until the sensitive data protection service 104 (e.g., the response component 204) determines that the updated generic response data provides an appropriate (e.g., suitable, helpful, sufficient) response to the user's initial request.

The sensitive data protection service 104 may send the actual response data 247 back to the user device 102. If the initial request comprises a request for the machine learning model 106 to perform some task related to the external system(s) 108, the sensitive data protection service 104 may additionally, or alternatively, send the actual response data 247 to the external system(s) 108. For example, a user may request for the machine learning model 106 to optimize a piece of code and to publish the optimized code to his or her development system. The actual response data 247 may comprise the optimized code. The sensitive data protection service 104 may send the optimized code to the user's development system. The sensitive data protection service 104 may send an acknowledgement to the user device 102. The acknowledgement may indicate that the optimized code has been deployed to the user's development system.

FIG. 3 shows an example system 300 for sending modified request data to the machine learning model 106 in chunks. The system 300 may comprise the sensitive data protection service 104, the server device 110, the data storage 112, and the machine learning model 106.

The server device 110 may comprise a DHCP server. The server device 110 may determine IP addresses, such as IP addresses associated with cable modems and/or mobile devices. The IP addresses may be associated with shortened leases (e.g., DHCP leases that are minutes, hours, or days long). The server device 110 may cause temporary storage of the IP addresses as IP address data 302 in the data storage 112. The sensitive data protection service 104 may divide the modified request data 207 into any number of chunks, such as the chunks 207a-c. The sensitive data protection service 104 may send the various chunks, such as the chunks 207a-c, to the machine learning model 106 using different IP addresses to further obfuscate the sensitive data.

For example, the sensitive data protection service 104 may send the chunk 207a to the machine learning model 106 using a first IP address selected from the IP address data 302, the chunk 207b to the machine learning model 106 using a second IP address selected from the IP address data 302, and the chunk 207c to the machine learning model 106 using a third IP address selected from the IP address data 302.

The sensitive data protection service 104 may send the chunk 207a to the machine learning model 106 using the first IP address based on sending the chunk 207a to the container 302a using the first IP address. The container 302a may send (e.g., forward) the chunk 207a to the machine learning model 106 using the first IP address. The sensitive data protection service 104 may send the chunk 207b to the machine learning model 106 using the second IP address based on sending the chunk 207b to the container 302b using the second IP address. The container 302b may send (e.g., forward) the chunk 207b to the machine learning model 106 using the second IP address. The sensitive data protection service 104 may send the chunk 207c to the machine learning model 106 using the third IP address based on sending the chunk 207c to the container 302c using the third IP address. The container 302c may send (e.g., forward) the chunk 207c to the machine learning model 106 using the third IP address.

If the sensitive data protection service 104 sends the modified request to the machine learning model 106 in chunks, the sensitive data protection service 104 may receive generic response data, such as the generic response data 217, from the machine learning model 106 in chunks, such as the chunks 217a-c. If the sensitive data protection service 104 receives the generic response data in chunks (e.g., chunks 217a-c), the sensitive data protection service 104 may aggregate (e.g., combine) the chunks to generate the generic response data.

The machine learning model 106 may send the chunk 217a to the sensitive data protection service 104 based on sending the chunk 217a to the container 302a using the first IP address. The container 302a may send (e.g., forward) the chunk 217a to the sensitive data protection service 104 using the first IP address. The machine learning model 106 may send the chunk 217b to the sensitive data protection service 104 using the second IP address based on sending the chunk 217b to the container 302b using the second IP address. The container 302b may send (e.g., forward) the chunk 217b to the sensitive data protection service 104 using the second IP address. The machine learning model 106 may send the chunk 217c to the sensitive data protection service 104 using the third IP address based on sending the chunk 217c to the container 302c using the third IP address. The container 302c may send (e.g., forward) the chunk 217c to the sensitive data protection service 104 using the third IP address.

Each of the containers 302a-d may comprise an application container, such as a Linux container, a Docker container, and/or the like. Each of the containers 302a-c may be implemented using one or more computing nodes, such as virtual machines, executed on a single device, such as a server device, and/or distributed across multiple devices, such as multiple server devices.

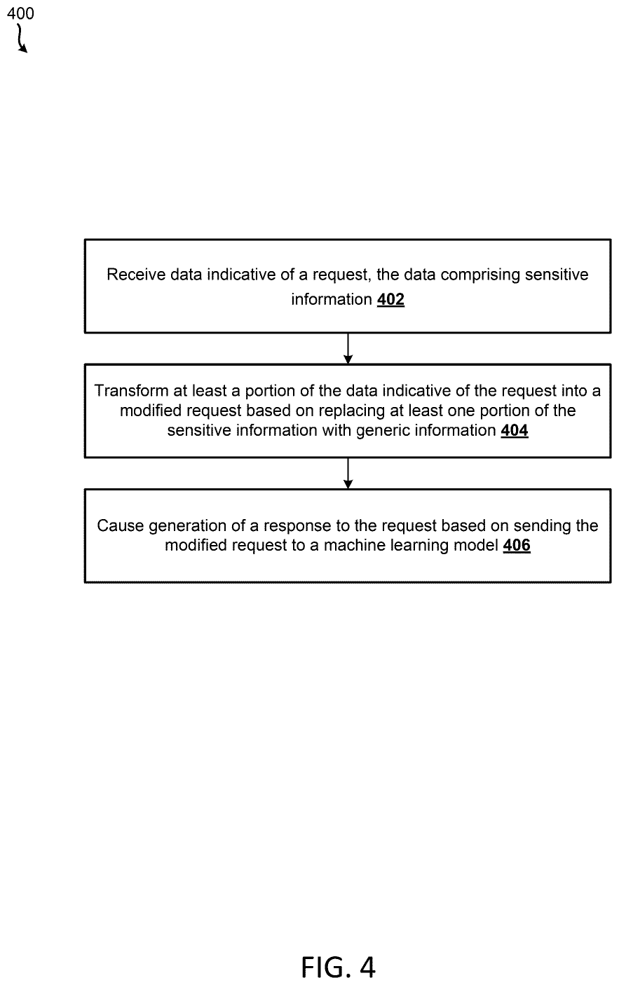

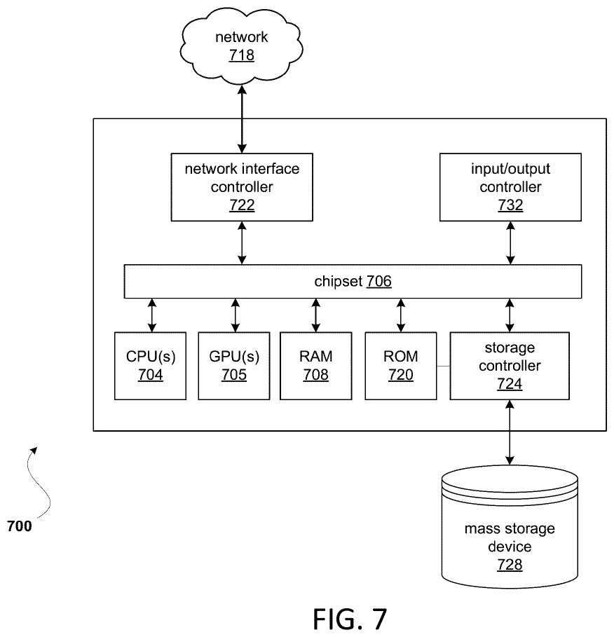

FIG. 4 is an example method 400. The method 400 may comprise a computer implemented method for managing sensitive data. A system and/or computing environment, such as the system 100 of FIG. 1 and/or the computing environment of FIG. 7, may be configured to perform the method 400. For example, the sensitive data protection service 104 of FIG. 1 may be configured to perform the method 400.

At 402, data may be received. The data may be indicative of a request. The data may comprise sensitive information, such as personal information, customer data, trade secrets, variable names, proprietary code, and/or the like. The request may comprise a request for a task to be performed by a machine learning model using the sensitive data. A user associated with a user device may use the user device to send (e.g., submit) the request. The request may comprise text, such as text that has been generated based on audio (e.g., speech) that the user captured using a microphone of the user device. The request may comprise code written in a programming language. For example, the request may comprise a request for the machine learning model to modify or optimize the code. The request may comprise a request for the machine learning model to perform some task related to the external system(s). For example, the request may comprise a request for the machine learning model to publish modified or optimized code to the external system(s).

At 404, at least a portion of the data indicative of the request may be transformed. The at least the portion of the data indicative of the request may be transformed into a modified request based on removing at least one portion of the sensitive information from the portion of the data indicative of the request. The at least the portion of the data indicative of the request may be transformed into the modified request based on replacing at least one portion of the sensitive information with generic information. The at least the portion of the data indicative of the request may be transformed into the modified request based on adding garbage (e.g., dummy, obfuscation) information to the data indicative of the request to further obfuscate the sensitive data.

At 406, generation of a response to the request may be caused. The generation of the response may be caused based on sending the modified request to the machine learning model. The machine learning model may receive the modified request and generate a response to the modified request without accessing the sensitive information contained in the request. The response to the modified request may be transformed into an actual (e.g., non-generic) response to the user's initial request by removing at least a portion of the generic data from the response to the modified request and/or by replacing at least a portion of the generic data in the response to the modified request with the sensitive information that was previously removed.

In this manner, the user may be able to utilize the machine learning model to perform the task involving sensitive data (e.g., generating a response to the request comprising sensitive data) while preventing the machine learning model from collecting and/or storing the sensitive data. This may be particularly advantageous given that the machine learning model is likely able to perform the task faster and/or more accurately than the user would otherwise be able to. The user can take advantage of the speed and efficiency provided by the machine learning model without having to worry that the machine learning model is accessing sensitive data.

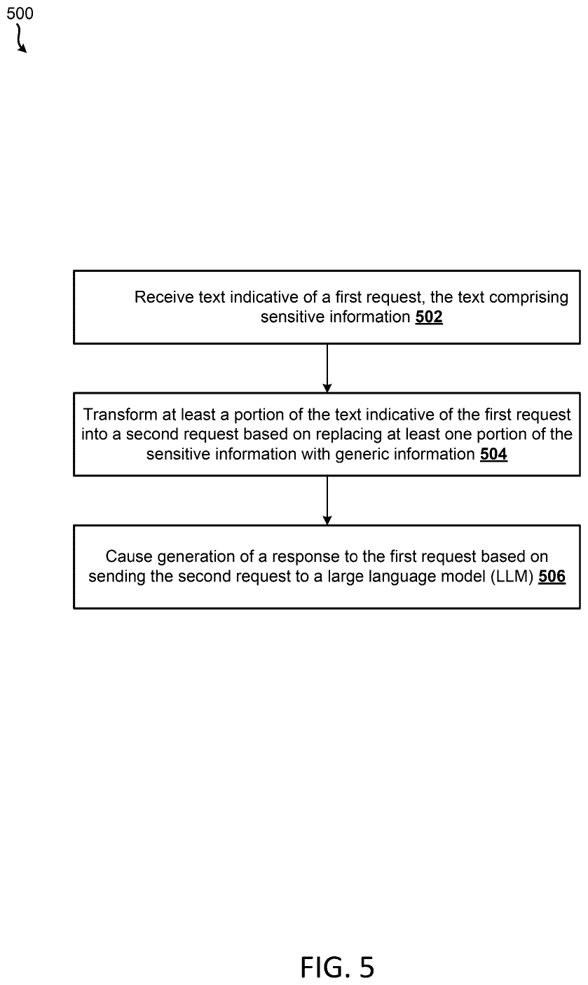

FIG. 5 is an example method 500. The method 500 may comprise a computer implemented method for managing sensitive data. A system and/or computing environment, such as the system 100 of FIG. 1 and/or the computing environment of FIG. 7, may be configured to perform the method 500. For example, the sensitive data protection service 104 of FIG. 1 may be configured to perform the method 500.

At 502, text may be received. The text may be indicative of a request. The text may comprise sensitive information, such as personal information, customer data, trade secrets, variable names, proprietary code, and/or the like. The request may comprise a request for a task to be performed by a machine learning model using the sensitive data. A user associated with a user device may use the user device to send (e.g., submit) the request. The text may be generated based on converting an audio request into text. The request may comprise code written in a programming language. For example, the request may comprise a request for the machine learning model to modify or optimize the code. The request may comprise a request for the machine learning model to perform some task related to the external system(s). For example, the request may comprise a request for the machine learning model to publish modified or optimized code to the external system(s).

At 504, at least a portion of the text indicative of the request may be transformed. The at least the portion of the text indicative of the request may be transformed into a second (e.g., modified) request based on removing at least one portion of the sensitive information from the portion of the text indicative of the request. The at least the portion of the text indicative of the request may be transformed into the second request based on replacing at least one portion of the sensitive information with generic information. The at least the portion of the text indicative of the request may be transformed into the second request based on adding garbage (e.g., dummy, obfuscation) information to the text indicative of the request to further obfuscate the sensitive text.

At 506, generation of a response to the request may be caused. The generation of the response may be caused based on sending the second request to a machine learning model configured to process natural language queries, such as an LLM. The machine learning model configured to process natural language queries may receive the second request and generate a response to the second request (e.g., a generic response) without ever accessing the sensitive information contained in the request. The response to the second request may be transformed into an actual (e.g., non-generic) response to the first request by removing at least a portion of the generic data from the response to the second request and/or by replacing at least a portion of the generic data in the response to the second request with the sensitive information that was previously removed. In this manner, the user may be able to utilize the machine learning model to perform the task involving sensitive data while preventing the machine learning model from collecting and/or storing the sensitive data.

In this manner, the user may be able to utilize the machine learning model to perform the task involving sensitive data (e.g., generating a response to the first request comprising sensitive data) while preventing the machine learning model from collecting and/or storing the sensitive data. This may be particularly advantageous given that the machine learning model is likely able to perform the task faster and/or more accurately than the user would otherwise be able to. The user can take advantage of the speed and efficiency provided by the machine learning model without having to worry that the machine learning model is accessing the sensitive data.

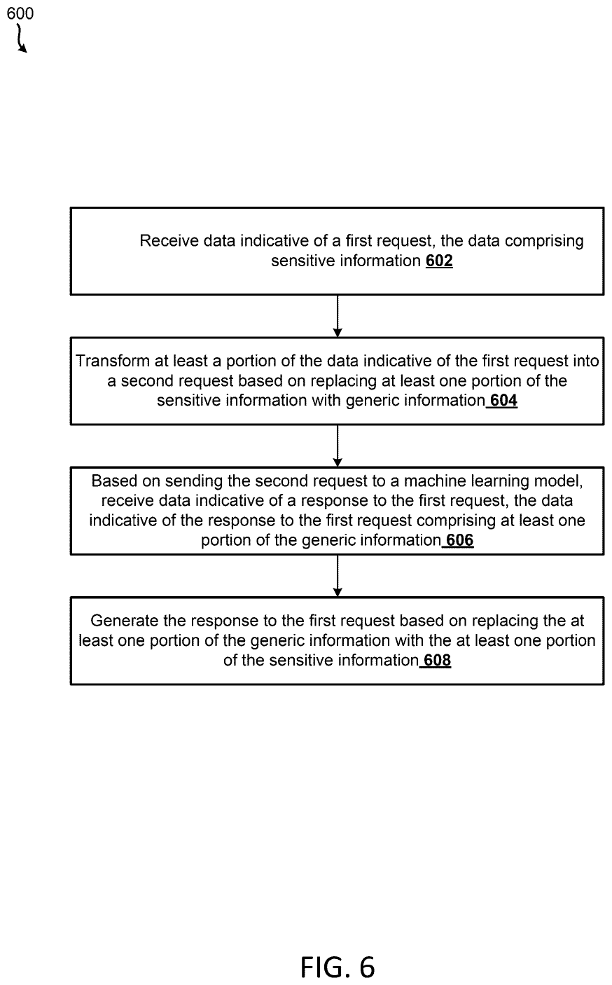

FIG. 6 is an example method 600. The method 600 may comprise a computer implemented method for managing sensitive data. A system and/or computing environment, such as the system 100 of FIG. 1 and/or the computing environment of FIG. 7, may be configured to perform the method 600. For example, the sensitive data protection service 104 of FIG. 1 may be configured to perform the method 600.

At 602, data may be received. The data may be indicative of a first request. The data may comprise sensitive information, such as personal information, customer data, trade secrets, variable names, proprietary code, and/or the like. The first request may comprise a request for a task to be performed by a machine learning model using the sensitive data. A user associated with a user device may use the user device to send (e.g., submit) the first request. The request may comprise audio (e.g., speech), such as audio that the user captured using a microphone of the user device. Alternatively, the first request may comprise text (e.g., natural language). The first request may comprise code written in a programming language. For example, the first request may comprise a request for the machine learning model to modify or optimize the code. The first request may comprise a request for the machine learning model to perform some task related to the external system(s). For example, the first request may comprise a request for the machine learning model to publish modified or optimized code to the external system(s).

At 604, at least a portion of the data indicative of the first request may be transformed. The at least the portion of the data indicative of the first request may be transformed into a second request based on removing at least one portion of the sensitive information from the portion of the data indicative of the request. The at least the portion of the data indicative of the first request may be transformed into the second request based on replacing at least one portion of the sensitive information with generic information. The at least the portion of the data indicative of the first request may be transformed into the second request based on adding garbage (e.g., dummy, obfuscation) information to the data indicative of the first request to further obfuscate the sensitive data.

Generation of a response to the first request may be caused. The generation of the response to the first request may be caused based on sending the second request to the machine learning model. The machine learning model may receive the second request and generate a response to the second request without accessing the sensitive information contained in the first request. At 606, data indicative of a response to the first request may be received. The data indicative of the response to the first request may be received based on sending the second request to the machine learning model. The data indicative of the response to the first request may comprise at least one portion of the generic information. At 608, the response to the first request may be generated. The response to the first request may be generated based on replacing the at least one portion of the generic information in the response to the second request with the at least one portion of the sensitive information.

In this manner, the user may be able to utilize the machine learning model to perform the task involving sensitive data (e.g., generating a response to the first request comprising sensitive data) while preventing the machine learning model from collecting and/or storing the sensitive data. This may be particularly advantageous given that the machine learning model is likely able to perform the task faster and/or more accurately than the user would otherwise be able to. The user can take advantage of the speed and efficiency provided by the machine learning model without having to worry that the machine learning model is accessing the sensitive data.

FIG. 7 depicts a computing device 700 that may be used in various aspects, such as the servers, devices, components systems, services, machine learning models, or storages depicted in FIG. 1. With regard to the example architecture of FIG. 1, any of the components or devices may each be implemented in an instance of a computing device 700 of FIG. 7.

The computer architecture shown in FIG. 7 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIGS. 4-6.

The computing device 700 may include a baseboard, or “motherboard,” which is a printed circuit board to which a multitude of components or devices may be connected by way of a system bus or other electrical communication paths. One or more central processing units (CPUs) 704 may operate in conjunction with a chipset 706. The CPU(s) 704 may be standard programmable processors that perform arithmetic and logical operations necessary for the operation of the computing device 700.

The CPU(s) 704 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 704 may be augmented with or replaced by other processing units, such as GPU(s) 705. The GPU(s) 705 may comprise processing units specialized for but not necessarily limited to highly parallel computations, such as graphics and other visualization-related processing.

A chipset 706 may provide an interface between the CPU(s) 704 and the remainder of the components and devices on the baseboard. The chipset 706 may provide an interface to a random access memory (RAM) 708 used as the main memory in the computing device 700. The chipset 706 may further provide an interface to a computer-readable storage medium, such as a read-only memory (ROM) 720 or non-volatile RAM (NVRAM) (not shown), for storing basic routines that may help to start up the computing device 700 and to transfer information between the various components and devices. ROM 720 or NVRAM may also store other software components necessary for the operation of the computing device 700 in accordance with the aspects described herein.

The computing device 700 may operate in a networked environment using logical connections to remote computing nodes and computer systems through local area network (LAN) 716. The chipset 706 may include functionality for providing network connectivity through a network interface controller (NIC) 722, such as a gigabit Ethernet adapter. A NIC 722 may be capable of connecting the computing device 700 to other computing nodes over a network 716. It should be appreciated that multiple NICs 722 may be present in the computing device 700, connecting the computing device to other types of networks and remote computer systems.

The computing device 700 may be connected to a mass storage device 728 that provides non-volatile storage for the computer. The mass storage device 728 may store system programs, application programs, other program modules, and data, which have been described in greater detail herein. The mass storage device 728 may be connected to the computing device 700 through a storage controller 724 connected to the chipset 706. The mass storage device 728 may consist of one or more physical storage units. A storage controller 724 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 700 may store data on a mass storage device 728 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 728 is characterized as primary or secondary storage and the like.

For example, the computing device 700 may store information to the mass storage device 728 by issuing instructions through a storage controller 724 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 700 may further read information from the mass storage device 728 by detecting the physical states or characteristics of one or more particular locations within the physical storage units.

In addition to the mass storage device 728 described above, the computing device 700 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 700.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 728 depicted in FIG. 7, may store an operating system utilized to control the operation of the computing device 700. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 728 may store other system or application programs and data utilized by the computing device 700.

The mass storage device 728 or other computer-readable storage media may also be encoded with computer-executable instructions, which, when loaded into the computing device 700, transforms the computing device from a general-purpose computing system into a special-purpose computer capable of implementing the aspects described herein. These computer-executable instructions transform the computing device 700 by specifying how the CPU(s) 704 transition between states, as described above. The computing device 700 may have access to computer-readable storage media storing computer-executable instructions, which, when executed by the computing device 700, may perform the methods described in relation to FIGS. 6-11.

A computing device, such as the computing device 700 depicted in FIG. 7, may also include an input/output controller 732 for receiving and processing input from a number of input devices, such as a keyboard, a mouse, a touchpad, a touch screen, an electronic stylus, or other type of input device. Similarly, an input/output controller 732 may provide output to a display, such as a computer monitor, a flat-panel display, a digital projector, a printer, a plotter, or other type of output device. It will be appreciated that the computing device 700 may not include all of the components shown in FIG. 7, may include other components that are not explicitly shown in FIG. 7, or may utilize an architecture completely different than that shown in FIG. 7.

As described herein, a computing device may be a physical computing device, such as the computing device 700 of FIG. 7. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, or in addition, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method comprising:
receiving data indicative of a request, wherein the data comprises sensitive information;
transforming at least a portion of the data indicative of the request into a modified request based on replacing at least one portion of the sensitive information with generic information; and
causing generation of a response to the request based on sending the modified request to a machine learning model, wherein the machine learning model is configured to generate data indicative of the response to the request without accessing the at least one portion of the sensitive information.

2. The method of claim 1, wherein the data indicative of the request and the data indicative of the response comprise text, and wherein the machine learning model comprises a large language model (LLM).

3. The method of claim 1, further comprising:
receiving, from the machine learning model, the data indicative of the response to the request, wherein the data indicative of the response to the request comprises at least one portion of the generic information; and
generating the response to the request based on replacing the at least one portion of the generic information with the at least one portion of the sensitive information.

4. The method of claim 1, further comprising:
removing at least one other portion of the sensitive information from the data indicative of the request to generate the portion of the data indicative of the request.

5. The method of claim 1, further comprising:
dividing the modified request into a plurality of modified requests, wherein sending the modified request to the machine learning model comprises sending the plurality of modified requests to the machine learning model.

6. The method of claim 1, further comprising determining a score associated with the modified request, wherein the score indicates an amount of the sensitive information associated with the modified request.

7. The method of claim 6, further comprising adding obfuscation information into the modified request based on determining that the score associated with the modified request does not satisfy a threshold, wherein the score does not satisfy the threshold if the amount of the sensitive information associated with the modified request is greater than a target level of sensitive information.

8. The method of claim 6, wherein sending the modified request to the machine learning model is based on determining that the score associated with the modified request satisfies a threshold, wherein the score satisfies the threshold if the amount of the sensitive information associated with the modified request is less than or equal to a target level of sensitive information.

9. A method comprising:
receiving text indicative of a first request, wherein the text comprises sensitive information;
transforming at least a portion of the text indicative of the request into a second request based on replacing at least one portion of the sensitive information with generic information; and
causing generation of a response to the first request based on sending the second request to a large language model (LLM), wherein the LLM is configured to generate text indicative of the response to the first request without accessing the at least one portion of the sensitive information.

10. The method of claim 9, further comprising:
dividing the second request into a plurality of second requests, wherein sending the second request to the LLM comprises sending the plurality of second requests to the LLM.

11. The method of claim 9, further comprising: determining a score associated with the second request, wherein the score indicates an amount of the sensitive information associated with the second request.

12. The method of claim 11, further comprising adding obfuscation information into the second request based on determining that the score associated with the second request does not satisfy a threshold, wherein the score does not satisfy the threshold if the amount of the sensitive information associated with the second request is greater than a target level of sensitive information.

13. The method of claim 11, wherein sending the second request to the LLM is based on determining that the score associated with the second request satisfies a threshold, wherein the score satisfies the threshold if the amount of the sensitive information associated with the second request is less than or equal to a target level of sensitive information.

14. A method comprising:
receiving data indicative of a first request, wherein the data comprises sensitive information;
transforming at least a portion of the data indicative of the first request into a second request based on replacing at least one portion of the sensitive information with generic information;
based on sending the second request to a machine learning model, receiving data indicative of a response to the first request, wherein the data indicative of the response to the first request comprises at least one portion of the generic information; and
generating the response to the first request based on replacing the at least one portion of the generic information with the at least one portion of the sensitive information.

15. The method of claim 14, wherein the machine learning model is configured to generate the data indicative of the response to the first request without accessing the at least one portion of the sensitive information.

16. The method of claim 14, wherein the data indicative of the first request and the data indicative of the response to the first request comprise text, and wherein the machine learning model comprises a large language model (LLM).

17. The method of claim 14, further comprising:
dividing the second request into a plurality of second requests, wherein sending the second request to the machine learning model comprises sending the plurality of second requests to the machine learning model.

18. The method of claim 14, further comprising determining a score associated with the second request, wherein the score indicates an amount of sensitive information associated with the second request.

19. The method of claim 18, further comprising adding obfuscation information into the second request based on determining that the score associated with the second request does not satisfy a threshold, wherein the score does not satisfy the threshold if the amount of sensitive information associated with the second request is greater than a target level of sensitive information.

20. The method of claim 19, wherein sending the second request to the machine learning model is based on determining that the score associated with the second request satisfies a threshold, wherein the score satisfies the threshold if the amount of sensitive information associated with the second request is less than or equal to a target level of sensitive information.
